(19) United States
(12) Patent Application Publication
(10) Pub. No.: US 2024/0220910 A1
(43) Pub. Date: Jul. 4, 2024

(54) BUILDING AND EXECUTING MACHINE LEARNING MODELS VIA A NO-CODE TOOLKIT

(71) Applicant: Nextworld, LLC, Greenwood Village, CO (US)

(72) Inventors: Luke Hollenback, Aurora, CO (US); Brigid Mulligan, Denver, CO (US)

(21) Appl. No.: 18/524,441

(22) Filed: Nov. 30, 2023

Related U.S. Application Data
(60) Provisional application No. 63/478,021, filed on Dec. 30, 2022.

(51) Int. Cl. G06Q 10/067; G06F 16/2458; G06F 16/31

(52) U.S. Cl. CPC G06Q 10/067; G06F 16/2458; G06F 16/31

(57) ABSTRACT

Various embodiments of the present technology include systems and methods for building, training, and executing new machine learning models via a no-code user environment. In some embodiments, a model definition is created by a user via a no-code machine learning model development toolkit and the model is queued for creation. A machine learning engine then implements processes described herein to build a machine learning model based on the model definition, train the model, automatically clean associated data for input into the model, and create a model instance to be stored in a model datastore. When new records are created or received, they may trigger the machine learning engine to run the model against the new record and provide valuable output.

### CROSS-REFERENCE TO RELATED APPLICATIONS

This application claims priority to U.S. Provisional Application Ser. No. 63/478,021 filed Dec. 30, 2022, which is incorporated herein by reference in its entirety for all purposes.

### BACKGROUND

Traditional approaches to big data processing require that humans or programmed machines make explicit, pre-determined decisions given a set of inputs. Machine learning, however, allows a machine to self-determine what decisions should be made given a set of inputs that may be ever-changing. Machine learning is a general form of artificial intelligence in which a machine builds a model of a concept. New data may be run through a trained model in order to generate a set of useful outputs. These outputs, which may include data classifications, trend predictions, and the like, can then be used to drive decisions. Creating machine learning models, however, is a complex process that requires advanced knowledge in computing programming and data exploration— skills that business developers typically lack the technical expertise and time for.

A machine learning model operates as a complex form of an algebraic equation. Thus, both the data being used to train a model and the data that is later run through the model to obtain valuable outputs must be quantifiable (i.e., represented numerically). Input dimensions operate as variables in the algebraic equation, and when a machine is training a model, it adjusts the coefficients accompanying each variable until it has developed a formula that returns a correct output value for a specified majority of the data. Various algorithms exist for finding ideal coefficients to create a working model. Examples of these algorithms include artificial neural networks, decision trees, support-vector machines, regression analysis, naïve bayes, and k-nearest neighbors.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some aspects of the present technology generally relate to systems and methods for building and executing machine learning models without requiring coding expertise. More specifically, the technology comprises a metadata-driven toolkit for building and running machine learning models in a no-code software environment. The toolkit allows a user, without any knowledge of the inner workings of machine learning techniques, to plug existing business processes and data into an application that creates and executes a machine learning model from the provided information. Thus, in certain embodiments, the technology acts as a plug-and-play classification tool that enables machine learning-based classification of new and existing customer data.

In a first embodiment, a method of operating at least one server comprises: upon creation of a new business record in a table, identifying a machine learning model stored in a database and associated with the table; loading the machine learning model; generating an input record including the new business record for input into the machine learning model, wherein generating the input record comprises formatting the input record to include attributes suitable for input to the machine learning model; providing the input record as input into the model; and receiving an output from the machine learning model.

In some embodiments, identifying the machine learning model comprises querying a model definition database for a model definition corresponding to the table, fetching the model definition corresponding to the table, and fetching the machine learning model based on information in the model definition. In some embodiments, the model definition comprises a name, a type, an identity of one or more data sources, one or more attributes, and one or more join definitions. Similarly, the model may comprise a model name, a model type, a specified algorithm, a last trained date, and the identify of an associated datastore. The model is stored as a serializable model object in certain embodiments. The method may further comprise building one or more join definitions according to information in the model definition. Cleaning the new business record for use in the machine learning model may comprise one or more of vectorizing, transforming, formatting, mapping, plumbing, pipelining, and quantifying the new business record in preparation for running it through the model. Receiving an output from the machine learning model may comprise one or more of populating an existing field in a table, adding a new field to a data source, tuning a business parameter, and providing operational insights via a user interface. In certain embodiments, the method further comprises generating business feedback based on the output and providing the business feedback to at least one business analytics environment.

In another embodiment, one or more computer-readable storage media have program instructions stored thereon for building machine learning models. The program instructions, when read and executed by a processing system, direct the processing system to at least: upon creation of a new model definition, obtain the model definition; generate a machine learning model based on the model definition; identify input records based on the model definition; format the input records for input into the machine learning model; train the machine learning model based on the input records; and store the model in a database.

In yet another embodiment, a system comprises one or more computer-readable storage media, a processing system operatively coupled with the one or more computer-readable storage media, and program instructions stored on the one or more computer-readable storage media for building machine learning models based on input via a no-code model development toolkit. The program instructions, when read and executed by the processing system, direct the processing system to at least: receive information, via a user interface of the no-code model development toolkit, that makes up a model definition, wherein the model definition comprises identifiers of one or more data structures and a machine learning algorithm type; build a machine learning model based on the model definition, wherein the model is a machine learning model based on the algorithm type and input; prepare data records from the one or more data structures for input into the machine learning model; train the machine learning model based on the data records; and store the machine learning model.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an overview of a no-code machine learning environment in accordance with one or more embodiments of the present technology;

FIG. 2 is a flowchart illustrating a series of steps performed in a no-code machine learning model development environment in accordance with one or more embodiments of the present technology;

FIG. 3 is a flowchart illustrating a series of steps in a no-code machine learning model development environment in accordance with one or more embodiments of the present technology;

FIG. 4 is a flowchart illustrating a series of steps for running a machine learning model in accordance with one or more embodiments of the present technology;

FIG. 5 is a flowchart illustrating a series of steps for building a machine learning model in accordance with one or more embodiments of the present technology;

FIG. 6 is a flowchart illustrating a series of steps for training a machine learning model in accordance with one or more embodiments of the present technology;

FIG. 7 illustrates a high-level overview of a no-code machine learning environment in accordance with one or more embodiments of the present technology;

FIGS. 8A-8C illustrate an example of a user interface environment for defining a machine learning model in accordance with one or more embodiments of the present technology;

FIG. 9 illustrates an example of a user interface environment for editing a machine learning model in accordance with one or more embodiments of the present technology;

FIGS. 10A-10B illustrate an example of a user interface environment for launching a machine learning model in accordance with one or more embodiments of the present technology;

FIG. 11 is a flowchart illustrating a series of steps for defining a machine learning model in accordance with one or more embodiments of the present technology;

FIG. 12 illustrates a no-code ERP environment in which no-code machine learning development may be implemented in accordance with one or more embodiments of the present technology;

FIG. 13 is a flowchart illustrating a series of steps for providing useful business insights from no-code machine learning technology in accordance with one or more embodiments of the present technology;

FIG. 14 is an example of a computing system in which some embodiments of the present technology may be utilized.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Some aspects of the present technology generally relate to systems and methods for building and executing machine learning models without requiring coding expertise. More specifically, the technology comprises a metadata-driven toolkit for building and running machine learning models in a no-code software environment. The toolkit allows a user, without any knowledge of the inner workings of machine learning techniques, to plug existing business processes and data into an application that creates and executes a machine learning model from the provided information. When the toolkit is launched, the developer or similar user defines the intent, desires, and/or requirements for the model without having to write any code, such as via drop-down menus and other input fields. A background job is then initiated wherein the intent, desires, or requirements are translated into and stored as metadata, and used to build and train the model. In an exemplary embodiment of the present technology, the toolkit is included in a platform that also hosts some or all data sources that may be used in developing or running the model (e.g., financial transactions). The present technology is contemplated as being implemented, in some embodiments, in cloud-based enterprise resource planning (ERP) platforms and applications. However, the toolkit may also be implemented in a detached environment in which external data sources are sourced for purposes of developing or running the model.

Various technical effects may be appreciated from the implementations disclosed herein, including a reduction in time required in setting up machine learning models, eliminating the need to manually pipeline data sources into and integrate the model, and expanding machine-learning model creation to users with little or no coding expertise.

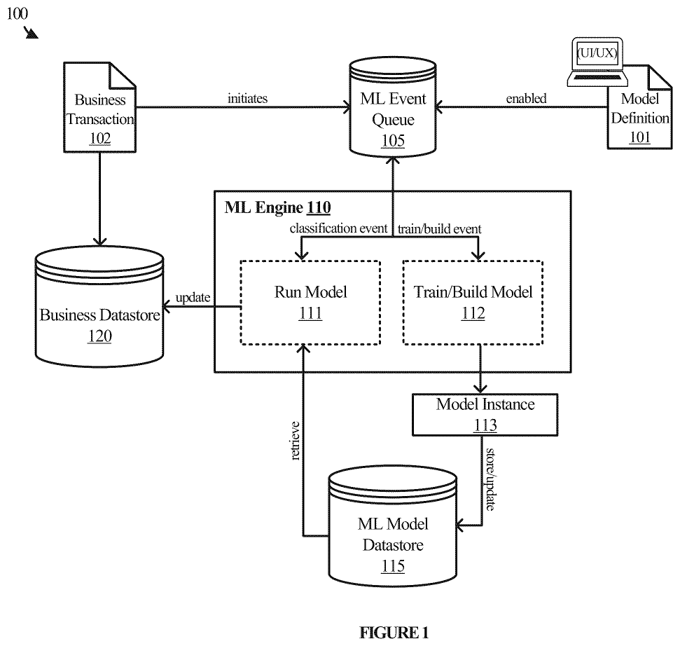

FIG. 1 illustrates no-code machine learning environment 100 in an implementation. No-code machine learning (ML) environment includes model definition 101, business transaction 102, ML event queue 105, ML engine 110, run model process 111, train/build model process 112, model instance 113, ML model datastore 115, and business datastore 120.

In accordance with the present disclosure, model definition 101 may be created on a client computing device by a user in a no-code machine learning toolkit. In some embodiments, the no-code machine learning toolkit is hosted on a tenant's cloud-based enterprise-resource planning (ERP) platform. Model definition 101 is a metadata type that points to various tenant data sources and labels the various dimensional columns of the data source. This metadata type allows for a machine learning model to be chosen and tuned. Model definition 101 may include a model name, type, algorithm, data source(s), attributes, join definitions, output, and/or other similar model-defining features. Via some or all of these options, a user can identify inputs, outputs, data sources, and model types that should be used to create and train a machine learning model.

Once model definition 101 is created, a user may, in accordance with the present implementation, enable the model definition, thereby queuing the creation of a model based on the model definition. Once model definition 101 is enabled, various background jobs begin ML events from existing tenant data residing in identified data sources and push them into ML event queue 105. Additionally, ML engine 110 begins pulling ML events from ML event queue 105 and processing them in order to build a model from existing, and perhaps pre-classified, tenant data, as well as to classify existing, unclassified data via the model. ML engine 110 is responsible for creating, training, maintaining, and persisting models into ML model datastore 115.

Thus, ML engine 110 implements train/build model process 112 to generate model instance 113, an instance of model definition 101. Model instance 113 is then stored in ML model datastore 115 for future use, editing, and/or training.

In accordance with the present disclosure, building and training the model is an automatic background process. This background process, performed by ML engine 110 includes, but is not limited to, automatic cleaning of data and automatic tuning and switching of the model. Cleaning the data may include one or more of vectorizing, transforming, formatting, mapping, plumbing, pipelining, categorizing and/or quantifying the data— processes that are traditionally time-consuming and user-intensive. The technology disclosed herein automatically writes any scripts necessary for transforming data from the tables and/or datastores into a format suitable for feeding into the machine learning model. Unlike existing technologies, the user is not required to manually pipeline the data into the model.

Once a model is created it may be run against and/or used to classify incoming data. When a new business transaction executes against a data source of an enabled model definition, a subsequent ML event is generated and pushed into ML event queue 105. Such events may take on different forms. For example, business transaction 102 may generate a classification or a training ML event. If the ML event is a classification event, it acts as a request for ML engine 110 to run the associated model to classify the new or updated record of tenant data. In this scenario, ML engine 110 may execute run model process 111 to classify the new event, and update business datastore 120 accordingly. If the ML event is a training event, it instead indicates that a user has explicitly classified a record of tenant data and that ML engine 110 should re-train the model accordingly, in which case ML engine 110 may run train/build model process 112. The type of ML event generated by business transaction 102 depends on the nature of business transaction 102.

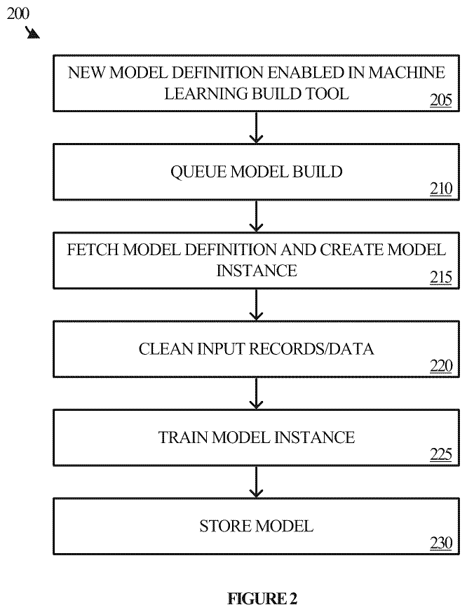

FIG. 2 illustrates process 200 for building a machine learning model in a no-code machine learning system as described herein. Process 200 may be implemented in program instructions in the context of any combination of the software applications, modules, components, or other such elements of one or more computing devices. For example, process 200 may be employed by one or more applications running on one or more computing devices in a cloud-based enterprise-resource planning platform, including elements shown in no-code machine learning environment 100 of FIG. 1. Program instructions direct the one or more computing devices to operate as follows, referring to a computing device in the singular form for purposes of clarity.

In step 205 of process 200, the computing device enables a new model definition (e.g., model definition 101) in a machine learning build tool. The new model definition is stored as a metadata type that points to various tenant data sources and labels the various dimensional columns of the data source(s). In response to enablement of the new model definition, the computing device queues the model build in step 210 of process 200. In some embodiments, queuing the model build comprises various background jobs beginning ML events from existing tenant data residing in identified data sources and pushing them into an ML event queue (e.g., ML event queue 105).

In step 215 of process 200, the computing device fetches the model definition (e.g., model definition 101) and creates an instance of the model definition (e.g., model instance 113). In step 220, the computing device cleans input records and/or data for executing in the model instance. Cleaning the records and/or data may include one or more of vectorizing, transforming, formatting, mapping, plumbing, pipelining, categorizing and/or quantifying the records and/or data. In step 225 of process 200, the computing device trains the model instance (e.g., model instance 113). Training the model instance, in some examples, involves the use of pre-classified data to train the model against. In other examples, training the model is performed using other machine learning techniques, such as unsupervised learning or reinforcement training. Moreover, training model instances, in accordance with the present technology, may be achieved by leveraging existing trained models or existing datasets within the no-code ERP platform to inform and enable training of additional model instances. In step 230, the trained model is stored in a database (e.g., ML model datastore 115).

In an example, a model using a k-nearest neighbors algorithm is trained in a background process in accordance with the present disclosure. In a k-nearest neighbors algorithm, the computing device classifies records as certain types based on the type of its “nearest neighbors.” To train the model, the computing device must determine an optional “k” value (i.e., number of neighbors) for the model. Thus, the computing device may create a parameter optimization loop and run the model for each value of k less than 10. The model is tested against the given training set and returns an accuracy rating. Whichever value of k returns the highest accuracy is determined to be the k value for the model. In other examples, other algorithms may be used that have more than one parameter (i.e., more than “k”). In these scenarios, different combinations of values may be tested by the computing device to find the highest accuracy combination. These processes can be computationally burdensome and may take a long time to run. Thus, training a model as a background operation as described allows users to perform other tasks rather than needing to wait for the aforementioned training processes to run.

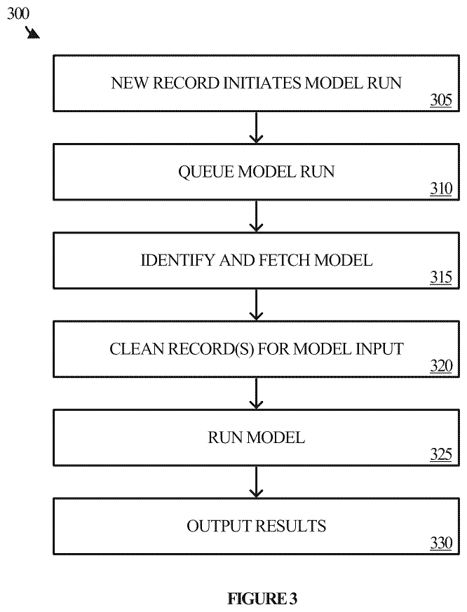

FIG. 3 illustrates process 300 for running a machine learning model in a no-code machine learning system as described herein. Process 300 may be implemented in program instructions in the context of any combination of the software applications, modules, components, or other such elements of one or more computing devices. For example, process 300 may be employed by one or more applications running on one or more computing devices in a cloud-based ERP platform, including elements shown in no-code machine learning environment 100 of FIG. 1. Program instructions direct the one or more computing devices to operate as follows, referring to a computing device in the singular form for purposes of clarity.

In step 305 of process 300, the computing device initiates a model run in response to creation or receipt of one or more new records (e.g., business transaction 102). In step 310, the computing device queues a model run. In some embodiments, queuing the model run comprises various background jobs beginning ML events from existing tenant data residing in identified data sources and pushing them into an ML event queue (e.g., ML event queue 105).

In step 315, the computing device identifies and fetches the model that is to be run. In some embodiments, fetching the model comprises first querying an appropriate database for the correct model definition, loading and initializing the model, and checking that the model is active. In step 320, the computing device cleans the new record(s) for use in the model. As previously discussed, cleaning the new record(s) comprises any one of or combination of vectorizing, transforming, formatting, mapping, plumbing, pipelining, categorizing and/or quantifying the record(s) in preparation for running the record(s) through the model.

In step 325, the model is run and an output is returned in step 330. Returning an output may take several forms in accordance with the present disclosure. In some examples, returning an output may include populating an existing field in a table, adding a new field to a data source, routing the output data back to where the input data was sourced from, tuning a business parameter, providing business or operational insights via a user interface, or similar.

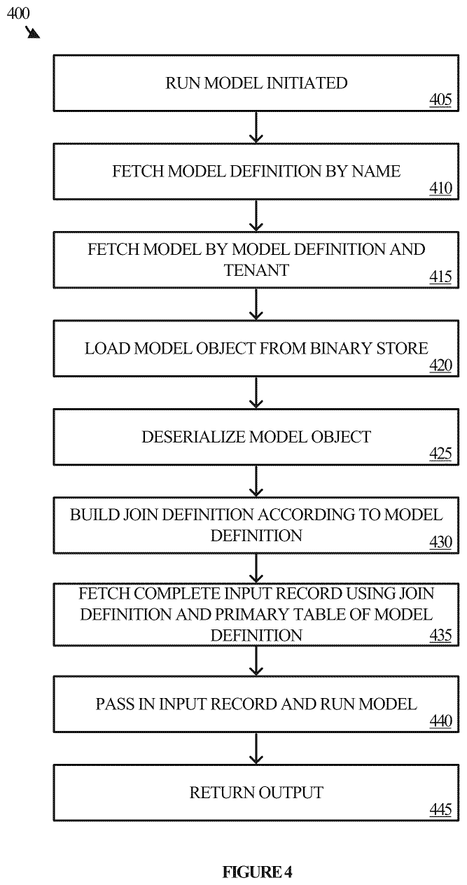

FIG. 4 illustrates process 400, which is representative of run model process 111 in some examples. Process 400 may be implemented in program instructions in the context of any combination of the software applications, modules, components, or other such elements of one or more computing devices. For example, process 400 may be employed by one or more applications running on one or more computing devices in a cloud-based ERP platform, including elements shown in no-code machine learning environment 100 of FIG. 1. In an exemplary embodiment, process 400 is performed by ML engine 110. Program instructions direct the one or more computing devices to operate as follows, referring to a computing device in the singular form for purposes of clarity.

In step 405, the computing device (e.g., ML engine 110) initiates running a model. In some instances, the run is initiated in response to the creation or receipt of one or more new records or data entries (e.g., business transaction 102) to a table associated with a stored model and/or in response to a new ML event being queued. In step 410, the computing device fetches the model definition (e.g., model definition 101) corresponding to the table by name and uses information in the model definition, as well as tenant information, to fetch the model (e.g., model instance 113) from storage (e.g., ML model datastore 115) in step 415, wherein the model is stored as a serializable model object. In step 420, the computing device loads the model object from the binary store and deserializes the model according to the model type (a model definition field) in step 425.

In step 430, the computing device builds one or more join definitions according to the model definition, wherein the join definitions are used to establish a connection between two or more tables. In step 435, the computing device fetches the complete input record for the model run using the join definition(s). The computing device also fetches the primary table (i.e., data source) as defined in the model definition. The computing device then passes in the input record and runs the model in step 440. In step 445, the computing device returns an output. As previously discussed, returning an output may take several different forms in accordance with the present disclosure. In some examples, returning an output may include populating an existing field in a table, adding a new field to a data source, routing the output data back to where the input data was sourced from, tuning a business parameter, providing business or operational insights via a user interface, or similar.

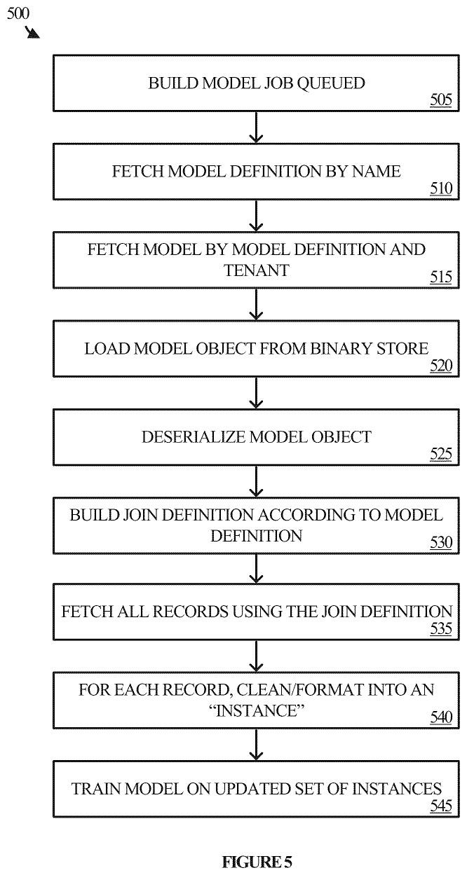

FIG. 5 illustrates process 500 for building a machine learning model in accordance with the present technology. Process 500 is representative of train/build model process 112 in the present example. Process 500 may be implemented in program instructions in the context of any combination of the software applications, modules, components, or other such elements of one or more computing devices. For example, process 500 may be employed by one or more applications running on one or more computing devices in a cloud-based ERP platform, including elements shown in no-code machine learning environment 100 of FIG. 1. In an exemplary embodiment, process 500 is performed by ML engine 110. Program instructions direct the one or more computing devices to operate as follows, referring to a computing device in the singular form for purposes of clarity.

In step 505, a build model job is queued. In some instances, once a model definition (e.g., model definition 101) is enabled, various background jobs begin ML events from existing tenant data residing in identified data sources and push them into an ML event queue (e.g., ML event queue 105). In step 510, the computing device fetches the model definition (e.g., model definition 101) by name and uses information in the model definition, as well as tenant information, to fetch the model (e.g., model instance 113) from storage (e.g., ML model datastore 115) in step 515, wherein the model is stored as a serializable model object. In step 520, the computing device loads the model object from the binary store and deserializes the model according to the model type (a model definition field) in step 525.

In step 530, the computing device builds one or more join definitions according to the model definition, wherein the join definitions are used to establish a connection between two or more tables. In step 535, the computing device fetches all records for training the model using the join definition(s). In some examples, such as in a first training, the training records are all records, or all records from a certain time period, as defined in the model definition. In other examples, such as during a re-train, the records may only include records or tables that have been added, changed, or updated since the last training. The computing device then cleans and formats each record into an “instance” in step 540, wherein an instance is in a suitable format to be run through the model. In step 545, the computing device trains the model on the updated set of instances before storing the newly trained model. Training, in accordance with the present technology, is a background process and may continue for extended periods of time depending on the machine learning approach used and/or the amount of data on which the model is trained.

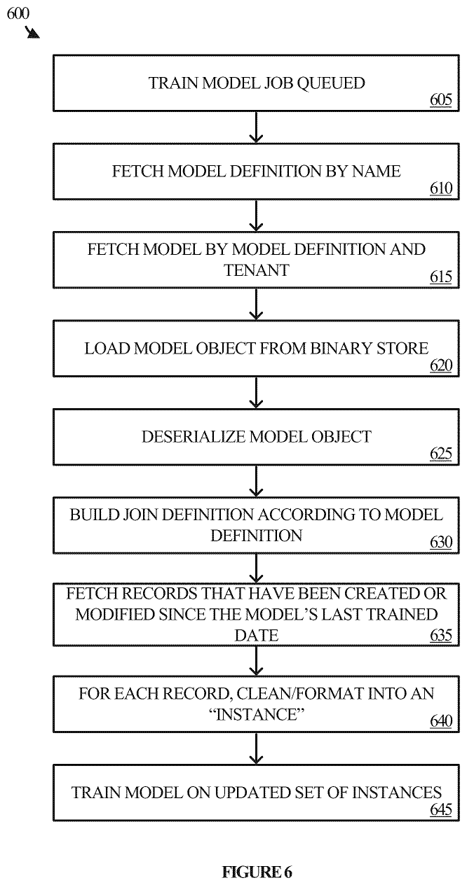

FIG. 6 illustrates process 600 for training a machine learning model in accordance with the present technology. Process 600 is representative of train/build model process 112 in the present example. Process 600 may be implemented in program instructions in the context of any combination of the software applications, modules, components, or other such elements of one or more computing devices. For example, process 600 may be employed by one or more applications running on one or more computing devices in a cloud-based ERP platform, including elements shown in no-code machine learning environment 100 of FIG. 1. In an exemplary embodiment, process 600 is performed by ML engine 110. Program instructions direct the one or more computing devices to operate as follows, referring to a computing device in the singular form for purposes of clarity.

In step 605, a train model job is queued. The train model job may be queued upon user request via no-code ML toolkit, or the train model job may be automatically queued upon a determination by one or more computing device that something in the model definition, model, and/or data sources has changed thereby necessitating a re-train. To queue the train model job, various background jobs begin ML events from existing tenant data residing in identified data sources and push them into an ML event queue (e.g., ML event queue 105). In step 610, the computing device fetches the model definition (e.g., model definition 101) by name and uses information in the model definition, as well as tenant information, to fetch the model (e.g., model instance 113) from storage (e.g., ML model datastore 115) in step 615, wherein the model is stored as a serializable model object. In step 620, the computing device loads the model object from the binary store and deserializes the model according to the model type (a model definition field) in step 625.

In step 630, the computing device builds one or more join definitions according to the model definition, wherein the join definitions are used to establish a connection between two or more tables. In step 635, the computing device fetches any or all records that have been created or modified since the model's last trained date. In some examples, such as in a first training, the training records are all records, or all records from a certain time period, as defined in the model definition. In other examples, such as during a re-train, the records may include only records or tables that have been added, changed, or updated since the last training. The computing device then cleans and formats each record into an “instance” in step 640, wherein an instance is in a suitable format to be run through the model. In step 645, the computing device trains the model on the updated set of instances before storing the newly trained model.

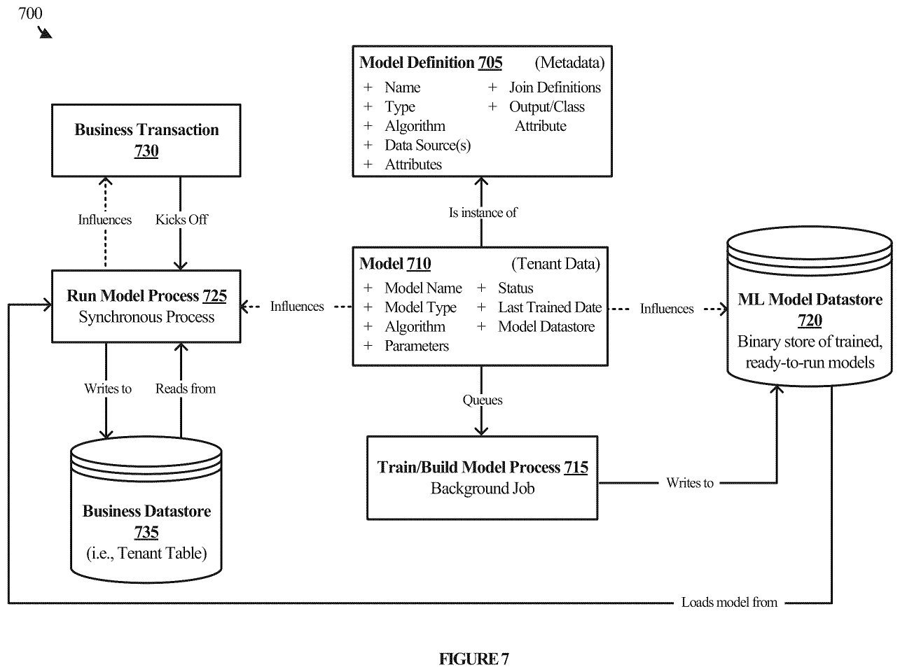

FIG. 7 illustrates no-code machine learning environment 700 in an implementation. No-code machine learning environment 700 includes model definition 705, model 710, train/build model process 715, ML model datastore 720, run model process 725, business transaction 730, and business datastore 735. Model definition 705 may be created via a user interface of a no-code machine learning toolkit in accordance with the present disclosure and stored in the form of metadata. Model definition 705 is a metadata type that points to various tenant data sources and labels the various dimensional columns of the data source. Model definition 705 includes a name, a type, an algorithm, one or more data sources, attributes, join definitions, and an output (i.e., class attribute). Elements included in model definition 705 may vary. For example, a user may indicate only one of a model type or an algorithm when creating the model definition. Attributes, in the present embodiment, are the variables, fields, or predictors that are used in the machine learning model. For example, in a predictive model, attributes are the predictors that affect a given outcome. Examples of attribute types include numeric, date, nominal, string, and relational. Examples of algorithm types are classification, regression, and prediction. Examples of algorithms include artificial neural networks, decision trees, support-vector machines, regression analysis, naïve bayes, and k-nearest neighbors.

Model 710 is an instance of model definition 705 and is stored as tenant data in ML model datastore 720. Model 710 includes a model name, a model type, a specified algorithm, parameters, a status (e.g., active or disabled), a last trained date, and an associated model datastore (e.g., ML model datastore 720). When model 710 is queued for a build or train process, train/build model process 715 is initiated and run as a background job without interrupting any front-end operations such as the use of an associated business application or the no-code machine learning toolkit. Once the build model process is complete, the built model is written to ML model datastore 720, a binary store of trained, ready-to-run models. Alternatively, if a model that is already built is trained via train/build model process 715, the newly trained model may be written to ML model datastore 720 and in some instances, may replace or overwrite previous versions of the model.

Moving on to run model process 725, run model process 725 is a synchronous process that may be initiated upon creation or receipt of a new record in a data table associated with model definition 705 and accompanying model 710 stored in ML model datastore 720. In the present example, the new record is business transaction 730. Business transaction 730, in some examples, is added to a table in business datastore 735, which stores one or more tenant tables. Creation of business transaction 730 kicks off run model process 725. In response, run model process 725 loads the associated model from ML model datastore 720 and reads any data for running the model from business datastore 735, as defined in model definition 705. Once the model has finished running, run model process 725 may write an output to one or more tables in business datastore 735.

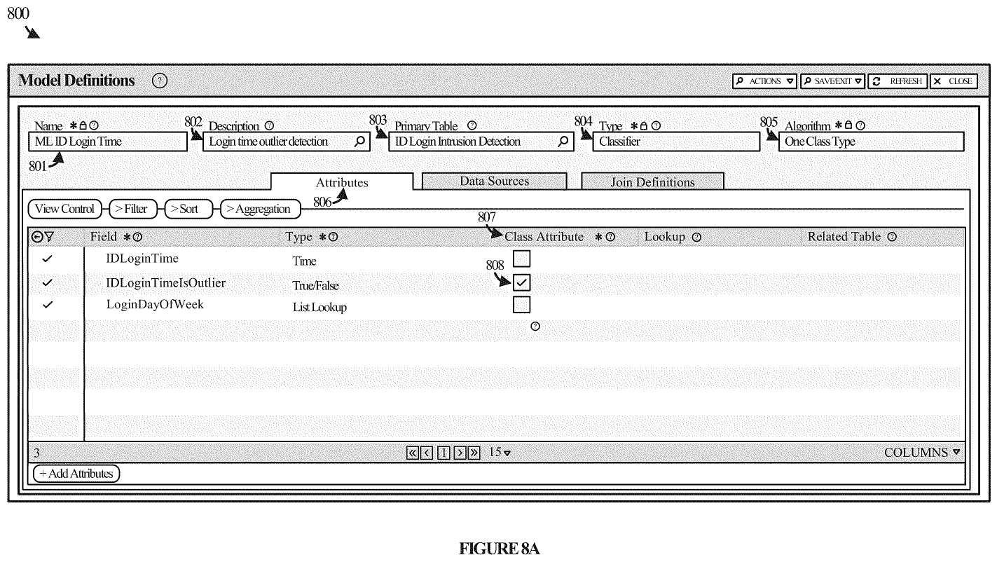

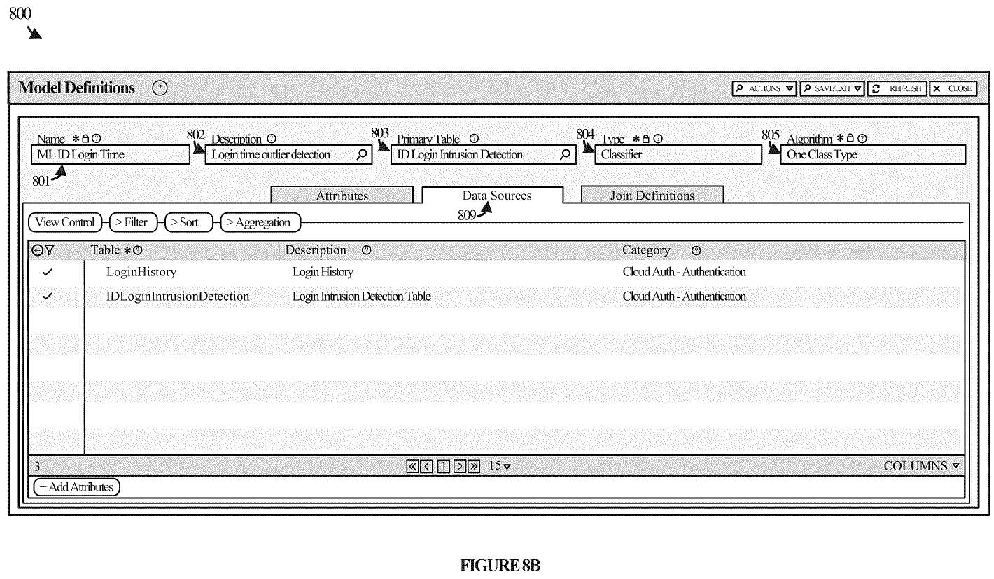

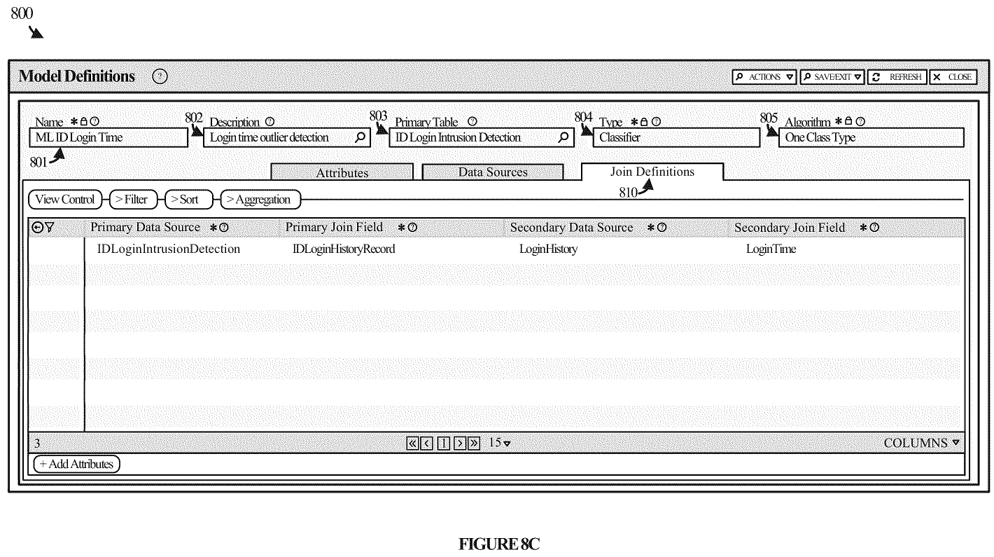

FIGS. 8A-8C illustrate an example of a user interface environment for creating model definitions (e.g., model definition 101 and model definition 705) in a no-code machine learning toolkit in accordance with one or more embodiments of the present technology. User experience 800 includes a model definitions window in which a model definition is created. User experience 800 includes name field 801, description field 802, primary table field 803, model type field 804, and algorithm field 805. In the present example, the model name is “ML ID Login Time” as entered in name field 801; the description is “Login time outlier detection” as entered in description field 802; the primary table of the model is “ID Login Intrusion Detection” as entered in primary table field 803; the algorithm type is “Classifier” as entered in model type field 804; and the specified algorithm is “One Class Type” as entered in algorithm field 805.

In FIG. 8A, attributes tab 806 is shown in user experience 800. Attributes tab 806 is where attributes of the machine learning model are defined. All attributes are fields in at least one data source (i.e., table) of the model. The attributes are referenced by their associated field in the primary table, wherein the primary table is defined in primary table field 803 of user experience 800. Class attribute column 807 is where the output (i.e., class attribute) is chosen. In the present example, the output, or class attribute, is “IDLoginTimeIsOutlier” in the primary table, which is an attribute expressed in a true/false format. The class attribute is selected in box 808 of class attribute column 807.

In FIG. 8B, data sources tab 809 is shown in user experience 800. Data sources tab 809 is where a user can select data sources for the model definition that will be used for running the model. In FIG. 8C, join definitions tab 810 is open in user experience 800. Join definitions are used to establish a connection between two or more tables. In the present example, the primary data source, “IDLoginIntrusionDetection” table, and the secondary data source, “LoginHistory” table, are indicated along with the primary join field, “IDLoginHistory,” and secondary join field, “LoginTime.”

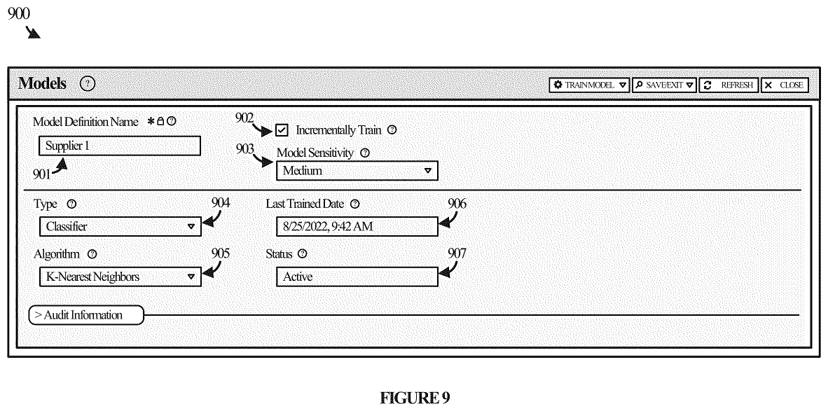

FIG. 9 illustrates an example of a user interface environment for viewing and/or editing a machine learning model in a no-code machine learning toolkit in accordance with one or more embodiments of the present technology. FIG. 9 includes user experience 900 displaying a models window in which model information may be viewed and/or edited. User experience 900 includes model definition name field 901, incrementally train option 902, model sensitivity field 903, model type field 904, algorithm field 905, last trained date field 906, and model status field 907. In the present example, the model definition name is “Supplier 1” as entered in model definition name field 901. The model is set to incrementally train in incrementally train option 902. Incremental training, in accordance with the present disclosure, comprises continually training the model with new records that have been added or modified since the last time the model was trained. When a model is incrementally trained, it is not re-trained from scratch on all or large portions of the data, thereby speeding up the training process and reducing computing needs.

The model sensitivity is set to medium, as shown in model sensitivity field 903. In an embodiment, model sensitivity field 903 has three options: low, medium, and high. The sensitivity of the model may affect the model's willingness to detect outliers. For example, if the model sensitivity is set too low, then it is assumed that outliers are infrequent, or they are very different from other outputs. If the model sensitivity is set to high, the model will find more outliers, assuming that they are more frequent or not very different from other outputs. In one embodiment, the default model sensitivity is “medium.”

Model type field 904 and algorithm field 905 reflect settings chosen in a model definitions portion of the toolkit, such as that shown in user experience 800 of FIGS. 8A-8C. In some examples, the model type and/or model algorithm are suggested or automatically chosen for a given model definition based on data types, data sources, attributes, and similar considerations. Last trained date field 906 indicates the date and time that the model was last trained, and model status field 907 indicates whether the model is active, enabled, or turned on by a user.

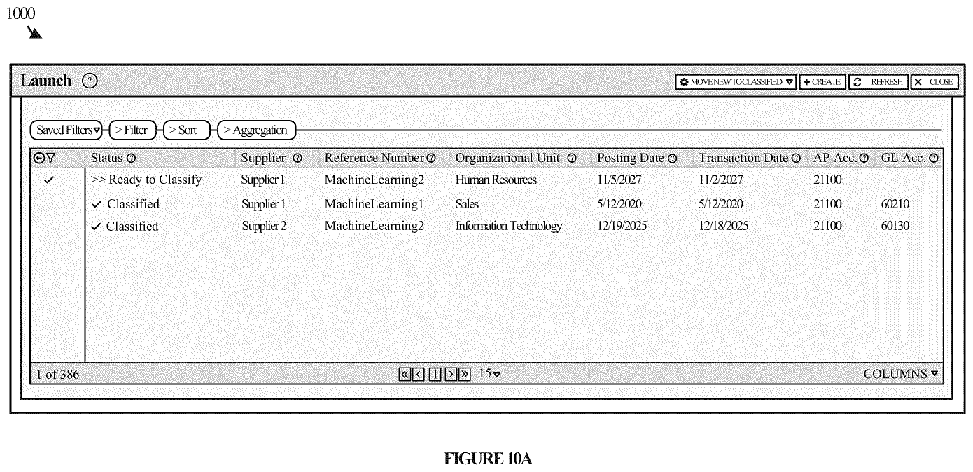

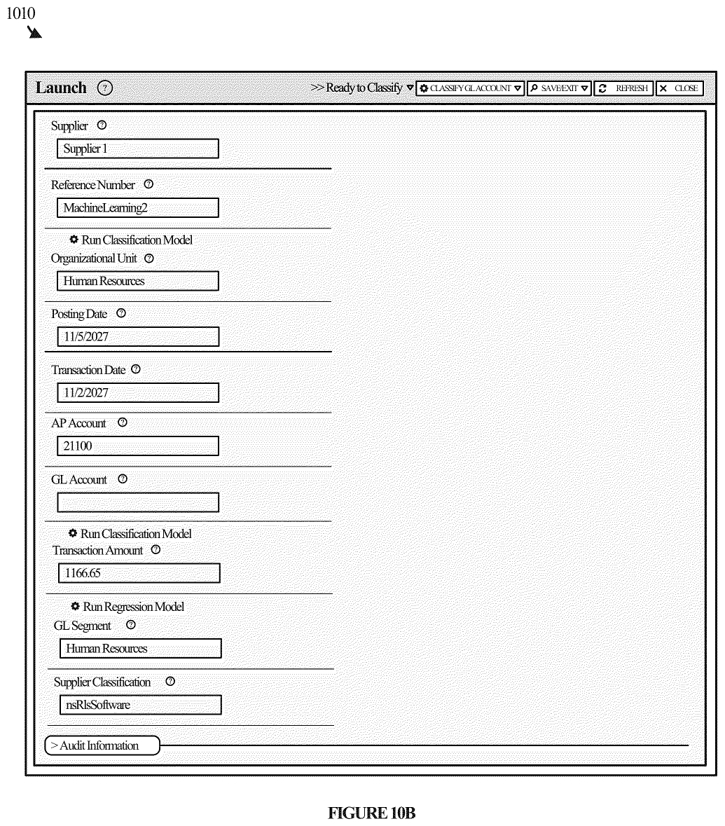

FIGS. 10A-10B illustrate an example of a user interface environment for launching machine learning models in a no-code machine learning toolkit in accordance with one or more embodiments of the technology disclosed herein. FIG. 10A includes user experience 1000 which includes a launch window displaying various business transactions that have been recently classified by a model or still need to be classified by a model, as well as their status (i.e., classified or ready to classify), the supplier, a model reference number, an associated organizational unit, a posted date, a transaction, date, and account numbers.

FIG. 10B includes user experience 1010 which includes a launch window for a specific business transaction that is ready to be classified. The launch window displays the supplier, the reference number, the organizational unit, the posting date, the transaction date, account numbers, the transaction amount, the general ledger segment, and the supplier classification. The launch window includes options to initiate classification of the transaction and/or initiate classification of entire accounts related to the transaction.

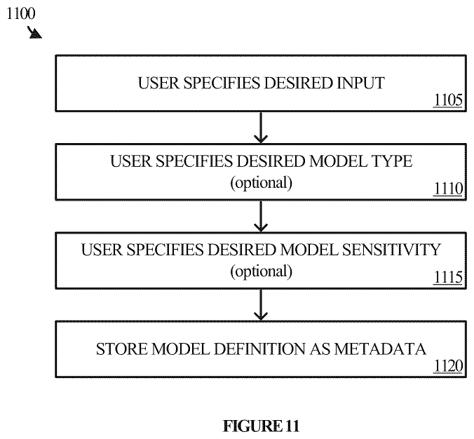

FIG. 11 illustrates process 1100 performed in the context of a no-code machine learning toolkit in accordance with some embodiments of the present technology. Step 1120 may be performed by one or more computing devices operating within the context of a no-code machine learning application, which may be hosted by a cloud-based ERP platform in some examples. In step 1105, a user specifies a desired input via one or more input fields in the toolkit (e.g., primary table field 803). Some or all of steps 1105-1115 may be performed by a user operating within a user interface like that shown in user experience 800 of FIGS. 8A-8C. In step 1110, the user specifies a desired model type via one or more input fields of the toolkit (e.g., model type field 804 and algorithm field 805). Step 1110 is optional because it may alternatively be performed by a computing device that automatically chooses a model type based on input information provided by the user. In step 1115, the user specifies a desired model sensitivity via one or more input fields of the toolkit (e.g., model sensitivity field 903). Step 1115 is also optional because it may alternatively be performed by a computing device that automatically chooses the model sensitivity based on input information and/or the model type. In step 1120, one or more computing devices store the information collected in steps 1105-1115 as a metadata model definition (e.g., model definition 101 and model definition 705).

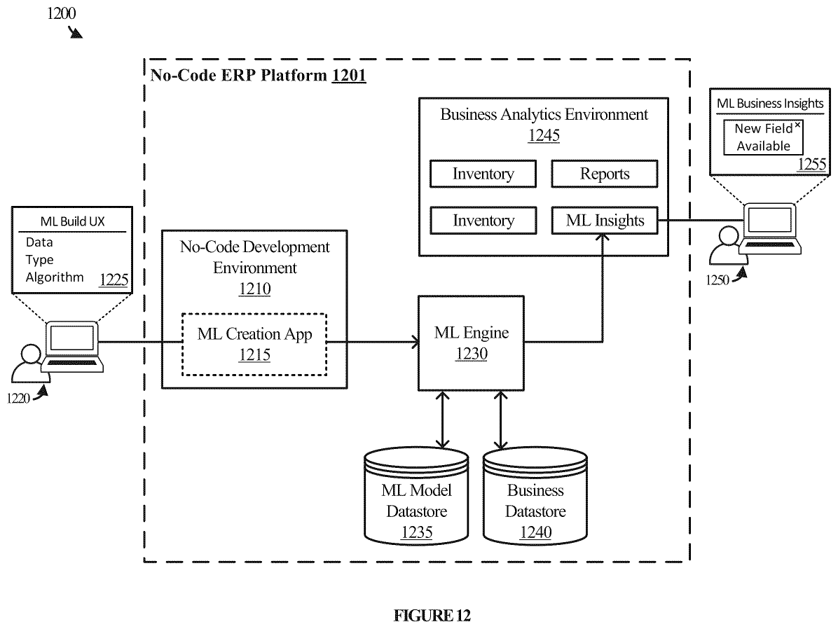

FIG. 12 illustrates no-code machine learning environment 1200 in an implementation. No-code machine learning environment 1200 includes no-code ERP platform 1201, a cloud-based ERP platform, client device 1220, and client device 1250. Client device 1220 and client device 1250 are both accessing no-code ERP platform 1201. No-code ERP platform 1201 comprises no-code development environment 1210, ML engine 1230, ML model datastore 1235, business datastore 1240, and business analytics environment 1245. Client device 1220 displays ML build user experience 1225 in the context of ML creation application 1215. Client device 1250 displays ML business insights user experience 1255 in the context of business analytics environment 1245.

No-code development environment 1210 includes ML creation application 1215 and is generally representative of a computing environment for defining, building, training, and running machine learning models without requiring users to code or manually pipeline data. ML creation application 1215 is generally representative of the no-code ML toolkit as described herein. ML build user experience 1225 is representative of any user experiences for defining, building, and running models (e.g., user experience 800, user experience 900, user experience 1000, and user experience 1010) in accordance with the present disclosure. No-code development environment 1210 and ML creation application 1215 are communicatively coupled with all resources inside of no-code ERP platform 1201, including but no limited to ML model datastore 1235, business datastore 1240, and business analytics environment 1245.

Once a machine learning model is defined and enabled via ML creation application 1215, it is queued for building and/or training in ML engine 1230. ML engine may read and/or write to and/or from ML model datastore 1235 and business datastore 1240 when building, training, or executing a model. ML engine 1230 is also responsible for executing trained models in response to new input events (e.g., business transaction 102 or business transaction 730). Upon executing a model, ML engine may write data back to business datastore 1240 and may optionally use the output as feedback into business analytics environment 1245, such as by populating information inside of an ML insights component of business analytics environment 1245, by surfacing a notification, by automatically filling existing data fields, by creating net new fields, or similar actions that use machine learning model outputs to inform business analytics they relate to. ML business insights user experience 1255 displayed on client device 1250 illustrates an example of a pop-up created in response to an output from ML engine 1230.

No-code machine learning environment 1200 and no-code ERP platform 1201 provide an ideal environment for implementing the technology of the present disclosure. No-code ERP platform 1201, in an example, comprises a translation/metadata layer, such that all users on the front end of the platform may create code and/or applications via the platform via metadata and without the need to know or use any programming languages. Thus, the data stored in any databases inside no-code ERP platform 1201 is already stored in metadata (e.g., field definitions), thereby enabling the metadata-driven machine learning model creation process described herein and easy integration of datastores already existing on the platform. Unlike existing technologies, no “bolt-in” integration process is required for all of the associated data, models, and/or products. The user is not required to write code to feed the data into the model, nor is the user required to write or format attributes or write weights for the model.

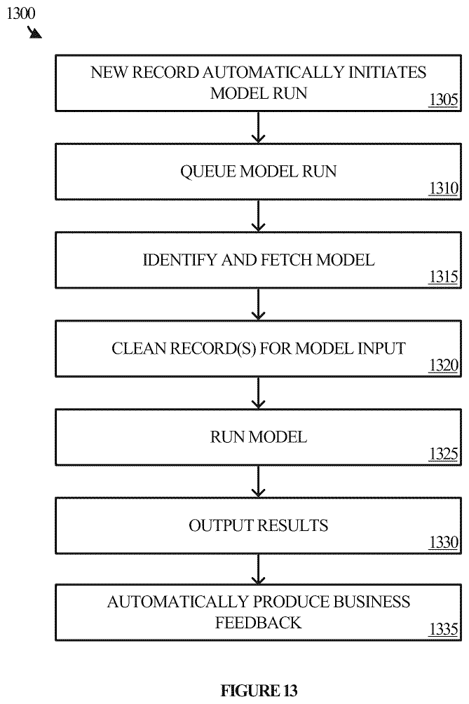

FIG. 13 illustrates process 1300 for running a machine learning model in the context of a no-code ERP platform as described herein. Process 1300 may be implemented in program instructions in the context of any combination of the software applications, modules, components, or other such elements of one or more computing devices. For example, process 1300 may be employed by one or more applications running on one or more computing devices in a cloud-based ERP platform (e.g., no-code ERP platform 1201), including elements shown in no-code machine learning environment 100 of FIG. 1 and no-code machine learning environment 1200. Program instructions direct the one or more computing devices to operate as follows, referring to a computing device in the singular form for purposes of clarity.

In step 1305 of process 1300, the computing device initiates a model run in response to creation or receipt of one or more new records (e.g., business transaction 102 or business transaction 730). In step 1310, the computing device queues a model run. In some embodiments, queuing the model run comprises various background jobs beginning ML events from existing tenant data residing in identified data sources and pushing them into an ML event queue (e.g., ML event queue 105).

In step 1315, the computing device identifies and fetches the model that is to be run. In some embodiments, fetching the model comprises first querying an appropriate database (e.g., ML model datastore 1235) for the correct model definition, loading and initializing the model, and checking that the model is active. In step 1320, the computing device cleans the new record(s) for use in the model. As previously discussed, cleaning the new record(s) comprises any one of or combination of vectorizing, transforming, formatting, mapping, plumbing, pipelining, categorizing and/or quantifying the record(s) in preparation for running the model.

In step 1325, the model is run and an output is returned in step 1330. Finally, in step 1335, the computing device produces business feedback based on the output returned in step 1330. In producing business feedback, the computing device may write data back to any relevant business datastores and may optionally use the output as feedback into a business analytics environment and/or application(s) such as by populating information inside of an ML insights component of business analytics environment, by surfacing a notification, by automatically filling existing data fields, by creating net new fields, or similar actions that use machine learning model outputs to inform business analytics they relate to.

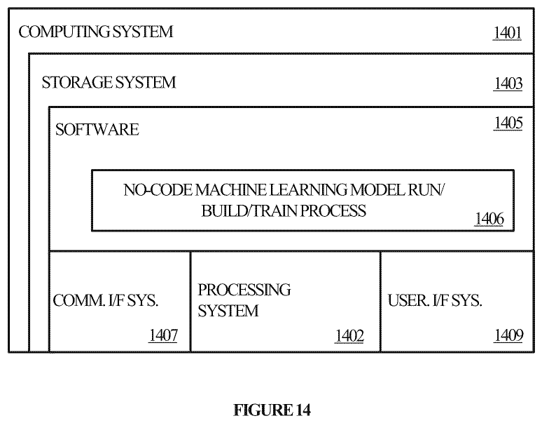

FIG. 14 illustrates computing system 1401 to perform no-code machine learning operations according to an implementation of the present technology. Computing system 1401 is representative of any computing system or collection of systems with which the various operational architectures, processes, scenarios, and sequences disclosed herein for defining, building, training, training, and/or running machine learning models. Computing system 1401 may be implemented as a single apparatus, system, or device or may be implemented in a distributed manner as multiple apparatuses, systems, or devices.

Computing system 1401 comprises storage system 1403, communication interface 1407, user interface 1409, and processing system 1402. Processing system 1402 is linked to communication interface 1407 and user interface 1409. Storage system 1403 stores operates software 1405, which includes no-code machine learning model run/build/train process 1406. Computing system 1401 may include other well-known components such as batteries and enclosures that are not shown in the present example for clarity. Examples of computing system 1401 include, but are not limited to, desktop computers, laptop computers, server computers, routers, web servers, cloud computing platforms, and data center equipment, as well as any other type of physical or virtual server machines, physical or virtual routers, containers, and any variation or combination thereof.

Processing system 1402 loads and executes software 1405 from storage system 1403. Software 1405 includes and implements no-code machine learning model run/build/train process 1406, which is representative of the operations discussed with respect to the preceding figures. When executed by processing system 1402 to perform the processes described herein, software 1405 directs processing system 1402 to operate as described for at least the various processes, operational scenarios, and sequences discussed in the foregoing implementations. Computing system 1401 may optionally include additional devices, features, or functionality not discussed for purposes of brevity.

Referring still to FIG. 14, processing system 1402 may comprise a micro-processor and other circuitry that retrieves and executes software 1405 from storage system 1403. Processing system 1402 may be implemented within a single processing device but may also be distributed across multiple processing devices or sub-systems that cooperate in executing program instructions. Examples of processing system 1402 include general purpose central processing units, graphical processing units, application specific processors, and logic devices, as well as any other type of processing devices, combinations, or variations thereof.

User interface 1409 comprises components that interact with a user to receive user inputs and to present media and/or information. User interface 1409 may include a speaker, microphone, buttons, lights, display screen, touch screen, touch pad, scroll wheel, communication port, or some other user input/output apparatus, including combinations thereof. User interface 1409 may be omitted in some examples.

Storage system 1403 may comprise any computer-readable storage media readable by processing system 1402 and capable of storing software 1405. Storage system 1403 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage media a propagated signal.

In addition to computer-readable storage media, in some implementations storage system 1403 may also include computer-readable communication media over which at least some of software 1405 may be communicated internally or externally. Storage system 1403 may be implemented as a single storage device but may also be implemented across multiple storage devices or sub-systems co-located or distributed relative to each other. Storage system 1403 may comprise additional elements, such as a controller, capable of communicating with processing system 1402 or possibly other systems.

Software 1405 (including no-code machine learning model run/build/train process 1406) may be implemented in program instructions and among other functions may, when executed by processing system 1402, direct processing system 1402 to operate as described with respect to the various operational scenarios, sequences, and processes illustrated herein. For example, software 1405 may include program instructions for building machine learning models in a cloud-based ERP application as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1405 may include additional processes, programs, or components, such as operating system software, virtualization software, or other application software. Software 1405 may also comprise firmware or some other form of machine-readable processing instructions executable by processing system 1402.

In general, software 1405 may, when loaded into processing system 1402 and executed, transform a suitable apparatus, system, or device (of which computing system 1401 is representative) overall from a general-purpose computing system into a special-purpose computing system customized to provide background no-code machine learning model functionality as described herein. Indeed, encoding software 1405 on storage system 1403 may transform the physical structure of storage system 1403. The specific transformation of the physical structure may depend on various factors in different implementations of this description. Examples of such factors may include, but are not limited to, the technology used to implement the storage media of storage system 1403 and whether the computer-storage media are characterized as primary or secondary storage, as well as other factors.

For example, if the computer readable storage media are implemented as semiconductor-based memory, software 1405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface 1407 may include communication connections and devices that allow for communication with other computing systems (not shown) over communication networks (not shown). Examples of connections and devices that together allow for inter-system communication may include network interface cards, ports, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. Communication interface 1407 may be configured to use Time Division Multiplex (TDM), Internet Protocol (IP), Ethernet, optical networking, wireless protocols, communication signaling, or some other communication format, including combinations thereof. The aforementioned media, connections, and devices are well known and need not be discussed at length here.

Communication between computing system 1401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The techniques introduced herein may be embodied as special-purpose hardware (e.g., circuitry), as programmable circuitry appropriately programmed with software and/or firmware, or as a combination of special-purpose and programmable circuitry. Hence, embodiments may include a machine-readable medium having stored thercon instructions which may be used to program a computer (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media or machine-readable medium suitable for storing electronic instructions.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “platform,” “environment,” or “system.” Furthermore, aspects of the present invention may take the form of a computer program product embodied in one or more computer readable medium(s) having computer readable program code embodied thercon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in cither this application or in a continuing application.

What is claimed is:

1. A method of operating at least one server, the method comprising:
upon creation of a new business record in a table, identifying a machine learning model stored in a database and associated with the table;
loading the machine learning model;
generating an input record including the new business record for input into the machine learning model, wherein generating the input record comprises, at least in part, cleaning the new business record for use in the machine learning model;
providing the input record as input into the machine learning model; and
receiving an output from the machine learning model.

2. The method of claim 1, wherein identifying the machine learning model comprises:
querying a model definition database for a model definition corresponding to the table;
fetching the model definition corresponding to the table; and
fetching the machine learning model based on information in the model definition.

3. The method of claim 2, wherein the model definition comprises a name, a type, an identity of one or more data sources, one or more attributes, and one or more join definitions.

4. The method of claim 2, wherein the machine learning model is stored as a serializable model object.

5. The method of claim 2, wherein the method further comprises building one or more join definitions according to information in the model definition.

6. The method of claim 1, wherein cleaning the new business record for use in the machine learning model comprises one or more of: vectorizing, transforming, formatting, mapping, plumbing, pipelining, and quantifying the new business record in preparation for running it through the machine learning model.

7. The method of claim 1, wherein receiving an output from the machine learning model comprises one or more of: populating an existing field in a table, adding a new field to a data source, tuning a business parameter, and providing operational insights via a user interface.

8. The method of claim 1, wherein the machine learning model comprises a model name, a model type, a specified algorithm, a last trained date, and an identity of an associated datastore.

9. The method of claim 1 further comprising generating business feedback based on the output.

10. The method of claim 9 further comprising providing the business feedback to at least one business analytics environment.

11. One or more computer-readable storage media having program instructions stored thereon for building machine learning models, wherein the program instructions, when read and executed by a processing system, direct the processing system to at least:
upon creation of a model definition, obtain the model definition;
generate a machine learning model instance based on the model definition;
identify input records based on the model definition;
format the input records for input into the machine learning model instance;
train the machine learning model instance based on the input records to create a trained model; and
store the trained model in a model database.

12. The one or more computer-readable storage media of claim 11, wherein to obtain the model definition, the program instructions, when read and executed by the processing system, direct the processing system to query a model definition database for the model definition.

13. The one or more computer-readable storage media of claim 11, wherein the model definition comprises a name, a type, an identity of one or more data sources, one or more attributes, and one or more join definitions.

14. The one or more computer-readable storage media of claim 11, wherein the program instructions, when read and executed by the processing system, further direct the processing system to build one or more join definitions according to information in the model definition.

15. The one or more computer-readable storage media of claim 11, wherein to format the input records for input into the machine learning model instance, the program instructions, when read and executed by the processing system, direct the processing system to perform one or more of vectorizing, transforming, mapping, plumbing, pipelining, and quantifying the input records in preparation for running them through the machine learning model instance.

16. The one or more computer-readable storage media of claim 11, wherein the trained model is stored as a serializable model object.

17. A system comprising:
one or more computer-readable storage media;
a processing system operatively coupled with the one or more computer-readable storage media; and
program instructions stored on the one or more computer-readable storage media for building machine learning models based on input via a no-code model development toolkit, wherein the program instructions, when read and executed by the processing system, direct the processing system to at least:
receive information, via a user interface of the no-code model development toolkit, that makes up a model definition, wherein the model definition comprises identifiers of one or more data structures and a machine learning algorithm type;
build a machine learning model based on the model definition;
clean data records from the one or more data structures in preparation for input into the machine learning model;
train the machine learning model based on the data records to create a trained model; and
store the trained model in a model database.

18. The system of claim 17, wherein the program instructions, when read and executed by the processing system, further direct the processing system to generate the model definition based on the information that makes up the model definition and store the model definition.

19. The system of claim 18, wherein the model definition further comprises a name, one or more attributes, and one or more join definitions.

20. The system of claim 18, wherein the program instructions, when read and executed by the processing system, further direct the processing system to build one or more join definitions according to information in the model definition.
